(19) United States
(12) Patent Application Publication
(10) Pub. No.: US 2024/0301932 A1
(43) Pub. Date: Sep. 12, 2024

(54) BALL-SCREW DRIVE FOR AN ACTUATOR ASSEMBLY, AN ACTUATOR ASSEMBLY, AND A METHOD FOR PRODUCING A BALL-SCREW DRIVE

(71) Applicants: ZF Active Safety US Inc., Livonia, MI (US); ZF Active Safety GmbH, Koblenz (DE)

(72) Inventors: Galus Chelaidite, Livonia, MI (US); Marco Becker, Oberduerenbach (DE); Michael Weins, Muenstermaifeld (DE); Florian Roessinger, Neuwied (DE); Lukas Madzgalla, Lahnstein (DE)

(21) Appl. No.: 18/583,921

(22) Filed: Feb. 22, 2024

Related U.S. Application Data
(63) Continuation-in-part of application No. 18/310,585, filed on May 2, 2023.

(30) Foreign Application Priority Data
Mar. 7, 2023 (DE) 102023105665.4

(51) Int. Cl. F16D 65/18; F16D 55/226; F16D 125/40

(52) U.S. Cl. CPC F16D 65/18; F16D 55/226; F16D 2125/40; F16D 2250/0023; F16D 2250/0046; F16D 2250/0084

(57) ABSTRACT

A ball-screw drive (16) for an actuator assembly (10) of a vehicle brake is indicated, comprising a rotatably mounted recirculating ball screw (18) on which a cup-shaped screw nut (20) is mounted. On the circumferential surface of the recirculating ball screw (18), at least one thread (26) is formed, and on the inner surface of the screw nut (20), a corresponding thread (28) is formed, wherein, in the threads (26, 28), a plurality of balls (30) are guided in such a way that a rotation of the recirculating ball screw (18) brings about an axial displacement of the screw nut (20) along an axis of rotation of the recirculating ball screw (18), The screw nut (20) is formed in two parts and has an inner part (36), in which the thread (28) is formed, and an outer part (38), on which the circumferential surface (34) of the screw nut (20) is formed, wherein the outer part (38) has protection against corrosion. Furthermore, an actuator assembly (10) and a method for producing a ball-screw drive (16) are indicated.

### TECHNICAL FIELD

The invention relates to a ball-screw drive for an actuator assembly of a vehicle brake, in particular for an electromechanically operated brake. The ball-screw drive has a recirculating ball screw, on which a screw nut is mounted. The invention further relates to an actuator assembly comprising a ball-screw drive and to a method for producing a ball-screw drive.

The screw nuts used in ball-screw drives are conventionally hardened in order to ensure sufficiently high resistance to the contact pressures occurring in the region of a thread containing the balls.

In an actuator assembly for a vehicle brake, the screw nut forms the brake piston. This means that the screw nut projects in some portions into a gap of a brake caliper in order to place a brake pad on a brake rotor. As a result, the screw nut is subjected to environmental conditions, for example moisture, in particular saline spray water, which promotes corrosion of the screw nut.

It is therefore necessary to provide the screw nut with sufficient protection against corrosion.

In this case, it is disadvantageous that, as a result of the conventional coating processes for applying protection against corrosion, the surface structure is changed after a previous hardening process, whereby the material on the surface becomes softer or porous. As a result, screw nuts which have protection against corrosion are less resistant to contact pressure in the region of the thread. This means that the screw nut wears more quickly.

### SUMMARY

The problem addressed by the invention is therefore that of providing a ball-screw drive for an actuator assembly of a vehicle brake which is optimized in terms of the corrosion resistance thereof and the resistance thereof to contact pressure.

This problem is solved according to the invention by a ball-screw drive for an actuator assembly of a vehicle brake, comprising a rotatably mounted recirculating ball screw on which a cup-shaped screw nut is mounted. On the circumferential surface of the recirculating ball screw, at least one thread is formed, and on the inner surface of the screw nut, a corresponding thread is formed, wherein, in the threads, a plurality of balls are guided in such a way that a rotation of the recirculating ball screw brings about an axial displacement of the screw nut along an axis of rotation of the recirculating ball screw. The screw nut is formed in two parts and has an inner part, in which the thread is formed, and an outer part, on which the circumferential surface of the screw nut is formed, wherein the outer part has protection against corrosion.

In particular, only the outer part has protection against corrosion.

As a result of the fact that the outer part has protection against corrosion, the screw nut is sufficiently resistant to environmental conditions when used as a brake piston. At the same time, the surface structure in the region of the thread is not negatively impacted by the protection against corrosion, and therefore there is sufficient resistance to the contact pressures occurring, which are Hertzian contact pressures.

The contact pressures are caused in particular by axial and radial forces when actuating the vehicle brake.

According to one embodiment, the inner part is open on both sides. In particular, the inner part is sleeve shaped. This is advantageous in that, when producing the thread, the inner part is accessible from both sides, whereby a tool for producing the thread does not have to be driven as far into the inner part.

In the case of an inner part which is open on both sides, the outer part is cup shaped, that is to say closed on one side, in order to form the overall cup-shaped geometry of the screw nut.

By means of the cup-shaped outer part, the screw nut is thus sealed in one direction, in particular on a side facing towards the brake pad, so that the interior of the screw nut, in which the thread is formed, is protected against the ingress of moisture.

The outer part is for example a deep-drawn part or a cold extruded component. In both cases, the outer part can be produced so as to be cup shaped. A deep-drawn part also has the advantage that it can be produced with a particularly thin wall thickness. This means that the screw nut is optimized in terms of the space requirements thereof.

According to one embodiment, the outer part is a deep-drawn part and is connected in an interlocking manner to the inner part. This is achieved in particular in that the outer part is plastically deformed after being placed on the inner part. In this case, there can be a clearance fit between the outer part and the inner part.

In another embodiment, the outer part is crimped on the inner part.

In an alternative embodiment, the outer part can be pressed onto the inner part. In this manner, a suitable connection is likewise achieved between the outer part and the inner part.

The inner part is preferably a hardened component. This means that the resistance of the screw nut to contact pressures in the region of the thread is additionally increased. Producing the screw nut in two parts prevents the protection against corrosion from diminishing the effect of the hardening process.

For example, the inner part is case hardened.

The end face of the outer part can have a reduced material thickness in the central region thereof. In particular, the main introduction of force during an actuation of the ball-screw drive in an actuator assembly takes place via an end-face annular surface of the inner part. The end face of the outer part can thus be formed so as to be thinner in the centre in order to save material.

For example, the outer part has a corrosion protection coating, in particular over the entire outer face or only on the part of the outer face which is exposed after attaching the inner part. The fact that the protection against corrosion is achieved by means of a coating means that there is a certain degree of flexibility when selecting the material.

According to one exemplary embodiment, the protection against corrosion is formed by ferritic nitrocarburizing.

In the case of a corrosion protection coating applied to the outer part, it is preferable for the corrosion protection coating to simultaneously improve the sliding properties of the outer part.

Alternatively, the entire outer part can consist of a corrosion-resistant material, in particular of a material which has a higher corrosion resistance than the material of the inner part.

In another alternative, it is conceivable for the protection against corrosion to result from a surface treatment which changes the surface structure of the material.

The problem is further solved by an actuator assembly for a vehicle brake, comprising a brake caliper unit which has a sleeve-shaped portion on which a running surface for the screw nut is formed, and comprising a ball-screw drive according to the invention, wherein the screw nut is guided in a non-rotational manner on the running surface of the sleeve-shaped portion by means of an anti-rotation device. This ensures that a rotation of the recirculating ball screw is translated completely into an axial movement of the screw nut.

In one embodiment, the anti-rotation device has at least one axially extending groove in the running surface and at least one anti-rotation member which sits in the groove in a rotationally fixed manner. In this case, the at least one anti-rotation member is formed integrally in the outer part. In other words, the anti-rotation member is formed integrally with the screw nut. In this manner, assembly is simplified, since the anti-rotation member is already securely connected to the screw nut from the start.

In this case, the at least one anti-rotation member can be guided in the assigned groove in an axially displaceable manner. In particular, in this case a plurality of anti-rotation members can be provided, wherein one groove is assigned to each anti-rotation member. As a result of the fact that the at least one anti-rotation member is guided in the groove in an axially displaceable manner, the displaceability of the screw nut is not impaired by the anti-rotation device.

Additionally or alternatively, the anti-rotation member can be a member which is elastically compressible in the radial direction. The anti-rotation member can thus be elastically compressed or displaced radially inwardly when inserted in the receiving portion. In particular, in the case of a correspondingly shaped groove, it is thus possible for the screw nut to engage in the receiving portion. Moreover, the anti-rotation member can be displaced more easily by means of an annular seal already arranged in the receiving portion, and damage to the annular seal is prevented.

According to one embodiment, the anti-rotation member is arcuate. In particular, the anti-rotation member is in the form of a U-shaped leaf spring. By means of the arcuate shape, the contact surface between the anti-rotation member and the running surface is reduced, which reduces friction.

Furthermore, it can be provided that the anti-rotation device is formed in such a way that the screw nut can be inserted, together with the anti-rotation member, in the axial direction into a receiving portion of the sleeve-shaped portion when the actuator assembly is assembled so that the anti-rotation member sits in the groove in a rotationally fixed manner In this case, the axial direction corresponds to the direction of movement of the brake piston when the brake piston is guided in the brake caliper unit. As a result of the fact that the screw nut can be inserted, together with the anti-rotation member, in the axial direction into the receiving portion, the assembly of the screw nut is greatly simplified by comparison with known solutions. The recess in the brake caliper unit can also be omitted so that the production of the brake caliper unit is also simplified.

The problem is further solved according to the invention by a method for producing a ball-screw drive according to the invention. In a first method step, an inner part of a screw nut, in which a thread is formed, and an outer part of a screw nut, on which the circumferential surface of the screw nut is formed, are provided. The outer part is provided with a corrosion protection coating in an immersion bath. After the coating, the outer part is connected via the inner part and fixed thereto.

Applying the corrosion protection coating in an immersion bath is particularly simple and quick in terms of production.

### BRIEF DESCRIPTION OF THE DRAWINGS

Further advantages and features of the invention can be found in the following description and from the accompanying drawings, to which reference is made. In the drawings,

FIG. 1 shows an actuator assembly according to the invention comprising a ball-screw drive according to the invention,

FIG. 2 shows a screw nut for a ball-screw drive according to the invention,

FIG. 3 shows the screw nut from FIG. 2 in a perspective sectional view,

FIG. 4 shows a screw nut comprising an anti-rotation member in a guide sleeve for an actuator assembly not according to the invention from FIG. 1 in a perspective sectional view,

FIG. 5 shows the screw nut and the guide sleeve from FIG. 4 in an exploded view,

FIG. 6 shows the anti-rotation member from FIGS. 4 and 5,

FIG. 7 shows another screw nut of another ball-screw drive according to the invention for an actuator assembly according to the invention, and

FIG. 8 is a perspective sectional view of the screw nut from FIG. 7.

### DESCRIPTION

FIG. 1 shows an actuator assembly 10 for a vehicle brake.

The actuator assembly 10 comprises a brake caliper unit 12, in which a gap 14 for a brake rotor is formed. For the sake of simplicity, in FIG. 1, the gap 14 is shown only in part.

Furthermore, the actuator assembly 10 comprises a ball-screw drive 16 having a rotatably mounted recirculating ball screw 18 on which a cup-shaped screw nut 20 is mounted.

In the brake caliper unit 12, a sleeve-shaped portion 22 is formed, on which a running surface 24 for the screw nut 20 is formed. The inner side of the sleeve-shaped portion 22 surrounds a receiving portion 21.

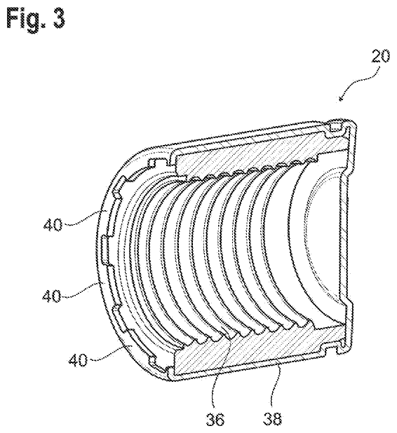

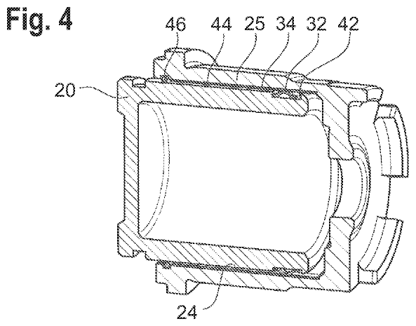

More specifically, the brake caliper unit 12 has a brake caliper 23 which has the running surface 24. In an alternative embodiment according to the invention, the brake caliper unit 12 can have a brake caliper 23 and a guide sleeve 25 (as shown for example in FIG. 4) received therein, which sleeve forms the running surface 24.

The screw nut 20 forms a brake piston which is used to place a brake pad on the brake rotor.

An axial displacement of the screw nut 20 is brought about by rotating the recirculating ball-screw 18.

More specifically, on the circumferential surface of the recirculating ball screw 18, at least one thread 26 is formed, and on the inner surface of the screw nut 20, a corresponding thread 28 is formed, wherein, in the threads 26, 28, a plurality of balls 30 are guided in such a way that a rotation of the recirculating ball screw 18 brings about an axial displacement of the screw nut 20 along an axis of rotation of the recirculating ball screw 18.

On the brake caliper unit 12, in particular on the running surface 24 of the sleeve-shaped portion 22, the screw nut 20 is guided in a rotationally fixed manner by means of an anti-rotation device.

For this purpose, in the exemplary embodiment illustrated in FIG. 1, an anti-rotation member 32 is attached to a circumferential surface 34 of the screw nut 20, which member is guided in an axially extending groove 35 in the brake caliper unit 12.

The anti-rotation member 32 is for example a pin.

As can be seen in FIG. 1, the screw nut 20 protrudes into the gap 14 and thus has an outer surface which is exposed in some portions. The exposed outer surface is subjected to environmental conditions such as moisture.

In order to make the screw nut 20 resistant to environmental conditions, protection against corrosion is provided.

As shown in FIG. 1, the screw nut 20 is formed in two parts, and comprises an inner part 36, in which the thread 28 is formed, and an outer part 38, on which the circumferential surface 34 of the screw nut 20 is formed.

The outer part 38, which has an exposed outer surface, has the protection against corrosion.

The inner part 36 is formed without protection against corrosion. Instead, the inner part 36 can be hardened, in particular at least in the region of the thread 28.

The protection against corrosion is produced on the outer part 38 for example in the form of a corrosion protection coating. Alternatively, for this purpose, the outer part 38 can consist of a corrosion-resistant material.

The corrosion protection coating can be applied to the entire outer surface or only to the outer surface of the outer part 38 that is exposed after attaching the inner part 36. It is also conceivable to apply the protection against corrosion only in the region of the outer part 38 which protrudes into the gap 14.

In order to apply the protection against corrosion, the outer part 38 can be immersed in an immersion bath. This process is especially advantageous when the entire outer surface is to be provided with protection against corrosion. Otherwise, the parts that are not to be coated would have to be covered, which increases the complexity.

In the exemplary embodiment according to FIG. 1, the inner part 36 and the outer part 38 are in the form of cold extruded components.

The inner part 36 is open on both sides, in particular has a sleeve-shaped design.

By contrast, the outer part 38 is cup shaped.

The end face of the outer part 38 has a reduced material thickness in the central region. In other words, the end face can be designed to be thinner in the centre in comparison with the region of the circumferential edge, since the force path extends over the circumferential wall of the screw nut 20 during an actuation of the actuator assembly 10.

In order to interconnect the two components, the outer part 38 is pressed onto the inner part 36.

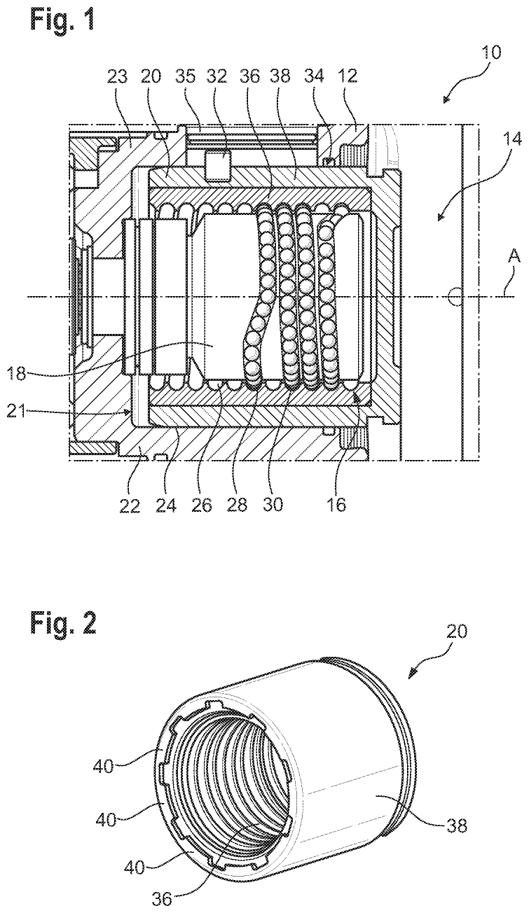

In FIGS. 2 and 3, a screw nut 20 is shown, which can be used as an alternative to the actuator assembly 10 shown in FIG. 1.

For like structures having like functions which are known from the embodiment above, the same reference signs are used in the following, and in this respect, reference is made to the preceding explanations, wherein in the following, the differences between the respective embodiments are described in detail to avoid repetition.

The screw nut 20 shown in FIGS. 2 and 3 differs from the screw nut 20 shown in FIG. 1 in particular in terms of the shape of the outer part 38.

The outer part 38 according to FIGS. 2 and 3 is in particular a deep-drawn part.

The outer part 38 being in the form of a deep-drawn part provides alternative possibilities for fixing the outer part 38 to the inner part 36.

More specifically, the outer part 38 can be fixed to the inner part 36 in an interlocking manner.

For this purpose, a plurality of tabs 40 are formed on the outer part 38. These are distributed over the circumference on the open side of the outer part 38.

Before the connection to the inner part 36, the tabs 40 on the outer part 38 extend in the axial direction.

After the outer part 38 has been put over the inner part 36, the tabs 40 are bent inwards into the position shown in FIG. 2, that is to say that the tabs 40 extend radially inwards.

In the case of an interlocking connection, there can be a certain amount of clearance between the inner part 36 and the outer part 38 in contrast to an interference fit.

Alternatively, it is also possible to crimp the inner part 36 to the outer part 38.

The assembly of an anti-rotation member 32 shown in FIG. 1 is relatively complex. For this purpose, the screw nut 20 must firstly be inserted in the brake caliper unit 12 and oriented correctly before the anti-rotation member 32 is inserted through the axially extending groove 35 from the outside and fixed to the screw nut 20.

FIGS. 4 to 8 each illustrate different solutions for producing an anti-rotation device in such a way that it is particularly simple to assemble the screw nut 20 and the anti-rotation device.

For this purpose, the assemblies illustrated in FIGS. 4 and 5, and 7 and 8 can each be integrated in the actuator assembly 10 illustrated in FIG. 1.

The groove 35 illustrated in FIG. 1 can be omitted so that the circumferential casing of the brake caliper 23 can remain closed.

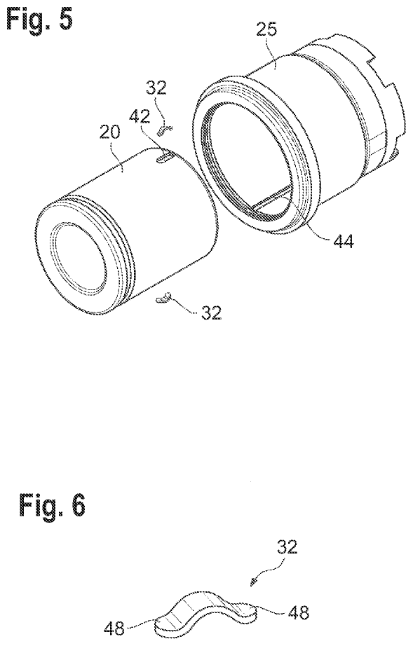

FIGS. 4 and 5 illustrate an embodiment of a screw nut 20 on which two anti-rotation members 32 are arranged.

In the exemplary embodiment according to FIGS. 4 and 5, the screw nut is formed in one piece.

The anti-rotation members 32 are members which are separate from the screw nut 20.

In order to be able to position the anti-rotation members 32 in a defined position on the screw nut, a depression 42 is formed on the circumferential surface 34 of the screw nut 20 for each anti-rotation member 32, in which depression in each case one anti-rotation member 32 is received in such a way that the anti-rotation member 32 protrudes beyond the circumferential surface 34 of the brake piston 20.

For the sake of easier handling, the anti-rotation member 32 can be magnetically held on the screw nut 20.

On the running surface 24, which in the exemplary embodiment according to FIGS. 4 and 5 is formed on the guide sleeve 25, two axially extending grooves 44 are formed which are assigned to the anti-rotation members 32.

The guide sleeve 25 is rigidly fixed in the brake caliper 23.

In each axially extending groove 44, an anti-rotation member 32 is received in such a way that the anti-rotation members 32 sit in the grooves 44 in a rotationally fixed manner.

More specifically, the anti-rotation members 32 are guided in the grooves 44 in an axially displaceable manner.

Together with the anti-rotation members 32, the grooves 44 form an anti-rotation device of the screw nut 20.

In the exemplary embodiment, the grooves 44 extend starting from an open end of the screw nut 20. However, it is also conceivable for the grooves 44 to start at a distance from the open end of the screw nut 20.

The number of anti-rotation members 32 and accordingly also of grooves 44 is not limited to two, it is also possible for a plurality of anti-rotation members 32 to be distributed over the circumference of the screw nut 20, for example three or four anti-rotation members 32.

The anti-rotation members 32 are elastically compressible in the radial direction.

When assembling the actuator assembly 10, the screw nut 20 is inserted together with the anti-rotation members 32 in the axial direction into the receiving portion 21.

As a result of the fact that the anti-rotation member 32 is elastically compressible in the radial direction, during assembly, the anti-rotation member 32 can move over an annular seal 46 which is already arranged on the running surface 24, in particular is received in a circumferential groove, before the screw nut 20 is mounted.

The anti-rotation member 32 is compressed radially inwardly when it is moved over the annular seal 46 during assembly. Damage to the annular seal 46 is thus prevented.

FIG. 6 shows an individual anti-rotation member 32. In FIG. 6, it is particularly easy to see that the anti-rotation member 32 is arcuate. To be more precise, the anti-rotation member 32 is a leaf spring.

Adjoining an arcuate portion, in the exemplary embodiment, the anti-rotation member 32 has two laterally protruding support portions 48, by means of which the anti-rotation member 32 is supported on the screw nut 20.

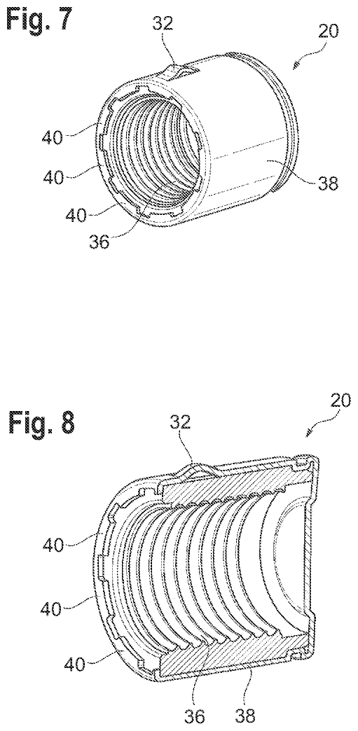

In FIGS. 7 and 8, another screw nut 20 is illustrated, which can be used in an actuator assembly 10 according to the invention.

Analogously to the screw nut 20 illustrated in FIGS. 2 and 3, the screw nut 20 illustrated in FIGS. 7 and 8 is designed in two parts and specifically comprises an inner part 36 and an outer part 38 on which the circumferential surface 34 of the brake piston 20 is formed.

By contrast with the screw nuts 20 illustrated in FIGS. 2 and 3, and 4 and 5, in the screw nut 20 shown in FIGS. 7 and 8, the anti-rotation member 32 is formed integrally in the screw nut 20, more specifically in the outer part 38.

In particular, in the outer part 38, a connecting portion is formed by punch-outs, the connecting portion being curved outwards in an arcuate manner and forming the anti-rotation member 32. This connecting portion can either deflect inwards or be radially rigid.

1. Ball-screw drive (16) for an actuator assembly (10) of a vehicle brake, comprising a rotatably mounted recirculating ball screw (18) on which a cup-shaped screw nut (20) is mounted,
wherein, on the circumferential surface of the recirculating ball screw (18), at least one thread (26) is formed, and on the inner surface of the screw nut (20), a corresponding thread (28) is formed, wherein, in the threads (26, 28), a plurality of balls (30) are guided in such a way that a rotation of the recirculating ball screw (18) brings about an axial displacement of the screw nut (20) along an axis of rotation of the recirculating ball screw (18),
wherein the screw nut (20) is formed in two parts, and comprises an inner part (36), in which the thread (28) is formed, and an outer part (38), on which the circumferential surface (34) of the screw nut (20) is formed, and
wherein the outer part (38) has protection against corrosion.

2. Ball-screw drive (16) according to claim 1, wherein the inner part (36) is open on both sides.

3. Ball-screw drive (16) according to claim 1, wherein the outer part (38) is a deep-drawn part or a cold extruded component.

4. Ball-screw drive (16) according to claim 3, wherein the outer part (38) is a deep-drawn part and is connected in an interlocking manner to the inner part (36).

5. Ball-screw drive (16) according to any of claims 1 to 3 claim 1, wherein the outer part (38) is pressed onto the inner part (36).

6. Ball-screw drive (16) according to claim 1, wherein the inner part (36) is a hardened component.

7. Ball-screw drive (16) according to claim 1, wherein the end face of the outer part (38) has a reduced material thickness in the central region thereof.

8. Ball-screw drive (16) according to claim 1, wherein the outer part (38) has a corrosion protection coating, in particular over the entire outer face or only on the part of the outer face which is exposed after attaching the inner part (36).

9. Ball-screw drive (16) according to claim 1, wherein, integrally on the outer circumference of the outer part (38), at least one anti-rotation member (32) is formed integrally in the outer part (44), which protrudes radially with respect to the outer circumference.

10. Ball-screw drive (16) according to claim 9, wherein the anti-rotation member (32) is a member which is elastically compressible in the radial direction.

11. Ball-screw drive (16) according to claim 9, wherein the anti-rotation member (32) is arcuate, in particular is in the form of a U-shaped leaf spring.

12. Actuator assembly (10) for a vehicle brake, comprising a brake caliper unit (12) which has a sleeve-shaped portion (22) on which a running surface (24) for the screw nut (20) is formed, and comprising a ball-screw drive (16) according to claim 1, wherein the screw nut (20) is guided in a non-rotational manner on the running surface (24) of the sleeve-shaped portion (22) by means of an anti-rotation device.

13. Actuator assembly (10) according to claim 12, wherein the anti-rotation device comprises at least one axially extending groove (44) in the running surface (24) and at least one anti-rotation member (32) which sits in the groove (44) in a rotationally fixed manner, the at least one anti-rotation member (32) being formed integrally in the outer part (44).

14. Actuator assembly (10) according to claim 13, wherein the at least one anti-rotation member (32) is guided in the assigned groove (44) in an axially displaceable manner, in particular a plurality of anti-rotation members (32) being provided, a groove (44) being assigned to each anti-rotation member (32).

15. Actuator assembly (10) according to claim 13, wherein the anti-rotation member (32) is a member which is elastically compressible in the radial direction.

16. Actuator assembly (10) according to claim 13, wherein the anti-rotation member (32) is arcuate, in particular is in the form of a U-shaped leaf spring.

17. Actuator assembly (10) according to claim 13, wherein the anti-rotation device is formed in such a way that the screw nut (20) can be inserted together with the anti-rotation member (32) in the axial direction into a receiving portion (21) of the sleeve-shaped portion (22) when the actuator assembly (10) is assembled so that the anti-rotation member (32) sits in the groove (44) in a rotationally fixed manner.

18. Method for producing a ball-screw drive (16) according to claim 1, comprising the following steps:
an inner part (36) of a screw nut (20) in which a thread (28) is formed, and an outer part (38) of a screw nut on which the circumferential surface (34) of the screw nut (20) is formed, are provided,
the outer part (38) is provided with a corrosion protection coating in an immersion bath,
after the coating, the outer part (38) is connected via the inner part (36) and fixed thereto.
